(19) United States
(12) Patent Application Publication
(10) Pub. No.: US 2006/0034967 A1
(43) Pub. Date: Feb. 16, 2006

(54) Device for carefully detaching and removing a press-molded part from a die

(76) Inventors: Uwe Habisreitinger, Lossburg (DE); Bernhard Nordmann, Schomberger (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/512,646

(22) PCT Filed: Mar. 15, 2003
(86) PCT No.: PCT/EP03/02727

§ 371 Date: Jul. 26, 2005

(30) Foreign Application Priority Data
Apr. 30, 2002 (DE) 102 19 276.6

(51) Int. Cl. B29C 45/40

(52) U.S. Cl. 425/436 R

(57) ABSTRACT

A device is provided for detaching a finish-molded workpiece, made of a thermoset, from a compression molding tool and for removing the workpiece from the molding press. In order to be able to carefully detach and remove compression molded parts of any desired shape from the compression molding tool, the removing gripper, which is preferably manipulated by an industrial robot, is designed according to the invention as a dimensionally stable suction bell which is adapted to the workpiece, covers the entire workpiece in a true-to-shape manner up to the workpiece edge and, with a contact-side soft-material seating, can be brought to bear in a sealing manner against the workpiece. Pockets which are sealed off from one another and each of which can be subjected individually to a vacuum are incorporated in the soft-material seating. Each of the separate vacuum connections mutually free of reaction is provided with a monitoring device which emits a signal in the event of a drop in vacuum below a threshold value. A plurality of plungers which can be set down on opposing surfaces on the lower die are attached to the edge of the suction bell. The removing gripper can be pushed off the lower die by the plungers.

### BACKGROUND AND SUMMARY OF THE INVENTION

The present invention is based on a device for removing a compression molded part from the compression molding tool as has been disclosed, for example, by an article by R. Brüssel and U. Weber “SMC-Teile vollautomatisch herstellen” [Fully automated production of SMC parts], published in the journal Kunststoffe, No. 79 (1989), pages 1149-1154—cited briefly below by [1].

In the method described in [1], a mixture of reactive thermosetting synthetic resin and fibers which is matched in weight to the finished component is taken as the basis for the production of SMC parts. To be precise, the matched quantity of raw material is obtained by cutting out cut-to-size parts of a certain size and shape from a fiber-mat sheet (prepreg sheet) delivered in roll form and by placing the cut-to-size parts together to form a mat stack. Such a mat stack is inserted in a precise position into an open molding tool of a press. The molding tool is heated to a temperature at which the reactive synthetic resin reacts chemically and sets. By initially slow closing of the molding tool located in the press, the raw material introduced is at first only heated, as a result of which the synthetic resin becomes soft and free-flowing. The molding tool is then closed under controlled force and speed, the softened raw material flowing away laterally and completely filling the cavity of the molding tool in the process. After this filling of the impression, the molding tool is kept closed for a time with defined force, so that the synthetic resin can completely react and harden. It is only at this point that the molding tool can be opened and the finished SMC part removed therefrom.

To demold the molded SMC part from the molding tool, pin-like ejectors are integrated at least in the lower die in [1]. When the molding tool is opened, i.e. when the upper die is lifted upward, first of all the SMC part must be released from the impression of the upper die, so that the SMC part reliably remains behind in the lower die. This can be ensured by ejector pins integrated in the upper die or—if compression marks must not be recognizable on the workpiece surface molded on the top side—by a parting agent applied to the impression surface of the upper tool. Detaching the workpiece from the upper tool impression, despite a parting agent applied to the surface, certainly requires a certain expenditure of force between molded part on the one hand and upper die on the other hand. However, the opening force of the press is always sufficient for this purpose. After the opening of the molding tool, the ejectors provided in [1] at any rate in the lower die come into action and lift the SMC part slightly from the impression of the lower die, so that it only rests loosely in the lower die and can easily be removed. A disadvantage with the plant according to [1] is that it has to rely on the use of integrated ejector pins for detaching the molded part from the lower impression. These ejector pins require thickened or stiffened material portions in or on the workpiece at the workpiece-side attachment locations, and these thickened or stiffened material portions, during the reaction or cooling of the plastic, lead to shrinkage, which stands out as slight sink marks on the visible side of the molded part. In the case of visually critical paneling parts, in particular in the case of enameled body parts, such sink marks would turn out to be unsightly and cannot be accepted. In addition, there is the risk of fritting of the one or the other ejector pin during the compression processing of reactive preliminary masses of thermosets, as a result of which the production process may be susceptible to malfunctions.

For the automated removal of the SMC part resting loosely in the lower die of the previously known press on account of the ejector pins, a removal implement having a gripper is provided in [1], this gripper moving into the press, taking hold of the molded part there and depositing it in an automatic molded-part magazine if it is satisfactory. According to [1], the molded part still located in the gripper is already checked for completeness by means of photoelectric barriers during the removal; if defects are discovered, an alarm is given and the production system is stopped temporarily for inspecting the molding tool. Nothing is stated in [1] with regard to the operating principle of the gripper itself. In any case, the known gripper is designed in its function in such a way that it can only remove an SMC part resting loosely in the lower die from the press, but is not able to detach the molded part from the impression of the lower die as well.

On account of the surface waviness, due to thickened material portions which have to be provided for ejector pins, on the visible side of the molded plastic parts, such ejector pins, in particular in the production of visually critical extruded plastic parts, have to be dispensed with and the molded parts have to be detached from the lower die in another way. Irrespective of, this, dispensing with ejector pins is also advisable in the cases in which—due to a certain workpiece form—the visible side of the workpiece has to be assigned to the impression of the lower die.

The applicant is not familiar with any method of detaching SMC molded parts from the lower die which can be automated or mechanized and which would not need ejector pins integrated in the tool. In tools without ejector pins, work is carried out with a parting agent applied beforehand to the surface, and the finished workpiece is manually detached from the lower die with difficulty after the opening of the press. In this case, a pointed object is used in an attempt to release the workpiece locally from the impression at an edge location point and compressed air is injected in order to widen the area of the resulting gap. In this way—locally mechanical release of the edge and pneumatic widening—the entire workpiece is gradually detached from the lower impression. Apart from the amount of time required for this and the arduous work on a heated tool and in ergonomically unfavorable space conditions, the workpiece is damaged often enough during this procedure, so that is becomes useless. In particular parts of large area are especially at risk during detachment effected in this way, since the center of the component, which in this case lies further away from the edge of the component, may still possibly adhere firmly to the tool impression despite a released edge. Lifting the already released component edge too forcibly may stress the molded part, still experiencing the heat of reaction, beyond the elastic limit and cause permanent deformations in it.

A method of producing thermoplastic molded parts is shown in European publication EP 461 365 B1, =[2], in which method a quantity of heated and softened thermoplastic adapted in terms of weight is inserted into an open molding tool of a press, the plastic compound is extruded into the cavity of the molding tool by closing the latter, and then the workpiece still located in the molding tool is cooled and finally removed from it. According to [2], a suction gripper which is manipulated by a manipulator movable in three axes and has two round suction cups per workpiece is used for the automated removal of the finished workpiece from the opened compression molding tool. Normally, during the manipulation of hard parts by suction grippers, adaptable suction cups of flexible material are used in which the suction-cup edge is designed as a thin sealing lip which opens like an umbrella toward the bottom and which can readily conform to surface unevenness and therefore provide a sound seal. In [2], reference is not expressly made to the fact that the removing gripper is merely used to remove the molded part already detached from the lower die and therefore only lying loosely in the lower die; however, this may be assumed in view of only the two suction cups per workpiece. There is also the fact that there is virtually no potential for malfunctions to occur due to fritting of the ejector pins during the compression processing of thermoplastics which do not react chemically, and the detachment of the molded part from the impression by means of ejector pins during the processing of such a material may also be assumed as a rule without expressly mentioning it.

The object of the invention is to improve the device so that compression molded parts of any desired shape can be carefully detached from the compression molding tool and removed from it.

This object is achieved according to the invention.

Accordingly, the removing gripper is designed as a dimensionally stable suction bell which is adapted to the workpiece and by means of which very high forces can be exerted on the workpiece by a vacuum which acts on the top workpiece surface, these forces enabling the workpiece to be carefully detached from the impression of the lower die. During the action of force, the workpiece is in no way deformed but rather is stabilized in its desired shape.

Expedient configurations of the invention are apparent from the dependent claims. In addition, the invention is explained in detail below with reference to an exemplary embodiment shown in the drawings.

### BRIEF DESCRIPTION OF THE DRAWINGS

FIG. 1 shows a schematic overall view of a process plant in a plan view,

FIG. 2 shows a vertical sectional view of the press and the removing tool attached to the workpiece,

FIG. 3 shows an enlarged longitudinal section through an exemplary embodiment of a safety valve for maintaining the vacuum despite any leakage in one of the pockets, subjected to vacuum, of the removing tool,

FIG. 4 shows an enlarged illustration of the detail IV in FIG. 2, showing a sealing profile between two adjacent pockets of the removing tool,

FIGS. 5 and 6 show two further exemplary embodiments of sealing profiles between two adjacent pockets of the removing tool in an illustration similar to FIG. 4, and

FIG. 7 shows a simplified plan view of the removing tool according to FIG. 2.

### DETAILED DESCRIPTION OF THE INVENTION

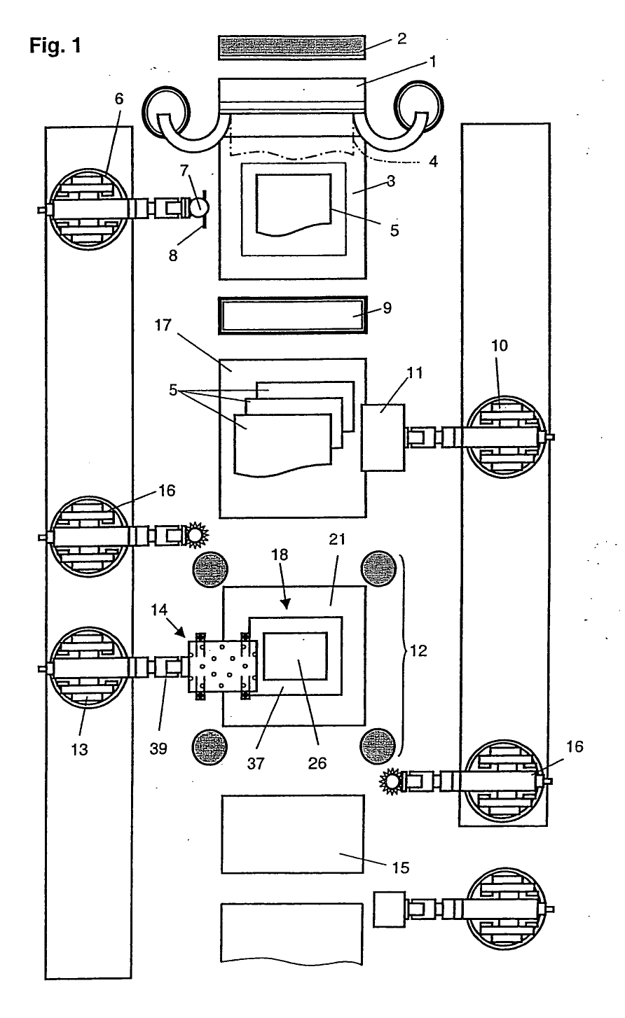

The process, on which the invention is based or which precedes the invention, for the mass production of SMC parts may be briefly explained with reference to the process scheme according to FIG. 1. The SMC parts are produced from a fibrous, reactive resin compound which is provided as initial product in the form of a virtually endless resin-mat sheet 4 wound into a supply roll 1. To maintain the reactivity of the synthetic resin in the resin-mat sheet, the latter is covered with a protective film 2, which is pulled off only just before the processing of the resin mat and is rolled up to form a separate coil 2. The protective film is deflected against the processing direction of the resin mat toward the coil 2 via a reversing bar located in the vicinity of the cutting-to-size table 3. The side edges of the resin-mat sheet are unsuitable for further processing and are cut off by a respective stationary cutting tool. The lateral scrap strips cut off at the sheet edge are likewise deflected via reversing bars into scrap containers.

The usable part of the resin-mat sheet is divided on the cutting-to-size table 3 provided with a very hard bearing surface, various cut-to-size pieces 5 of defined shape and size being cut out of said resin-mat sheet and being stacked to form a multi-layer resin-mat stack having a certain number and arrangement of layers. The scrap parts which accumulate in the process and cannot be used further are discharged into a corresponding scrap container 9. For mechanized and automated cutting-to-size, a cutting-to-size robot 6 is provided in the exemplary embodiment shown in FIG. 1 and guides a high-frequency rotary/oscillating saw blade 8 which is driven by a suitable motor 7.

The cut-to-size pieces 5 cut by the robot 6 on the table 3 are stacked on a separate weighing and stack-forming device 17 to form a resin-mat stack, the cut-to-size pieces being manipulated and moved by a manipulating robot 10, which in turn is provided with a resin-mat gripper 11 (not to be dealt with in any more detail here) which is specifically designed for this task and this substrate. Once the resin-mat stack has been formed in an appropriate shape for a new workpiece, the manipulating robot inserts said resin-mat stack in a defined position into a heated molding tool 18 of the molding press 12. The compression molding tool 18, which can be opened and closed by the molding press 12, consists of a lower die 24, mounted on the press table 21, together with its impression 26 and of an upper die 23, mounted on the press ram 22, together with impression 25. The heating of the molding tool 18 is not shown here.

By means of the press, the molding tool 18 is closed until the shaping surface of the cavity comes into contact with the inserted resin-mat stack and is clamped in the closing direction with a defined force, which is still small to begin with. Due to the contact with the hot tool, the resin compound heats up and softens as a result. On account of the closing force of the molding tool, the resin compound begins to flow and as a result finally completely fills the cavity of the increasingly closing molding tool 18. The tool is then held in the closed state for a certain time with increased force, in the course of which the resin compound is thermally cured. After this curing time has expired, the press 12 opens the tool, with the finished SMC part still lying in the lower, fixed tool half. The SMC part can be removed from the press and deposited in a cooling station 15 by a removing robot 13 provided with a removing tool 14. While the cutting-to-size and manipulating robots 6 and 10, respectively, prepare a new resin-mat stack, the opened molding tool 18 is cleaned by two cleaning robots 16, so that it is ready for receiving a new resin-mat stack.

The present invention involves a device for carefully detaching the finish-molded plastic workpiece 19 from the impression 26 of the lower die 24. In view of the visual requirements imposed on the visible workpiece surface 20 lying at the top, no ejector pins may be provided in the lower die.

Nonetheless, in order to be able to carefully detach and remove compression molded parts of any desired shape from the impression 26 of the lower part 24 of the compression molding tool 18, a removing gripper 14 is provided which is designed as a dimensionally stable suction bell adapted to the workpiece. The removing gripper is arranged on the wrist joint 39 of the multi-axis manipulating robot 13 and can be freely manipulated by it. The underside of the bell-shaped removing gripper is shaped in such a way that it covers the entire workpiece surface 20, exposed in the lower die 24, in a true-to-shape accurate manner right up to the workpiece edge accessible in the lower die 24. On the inside, the removing gripper, on the contact side of the suction bell, is provided with a soft material seating 27 which can be brought to bear against the workpiece 19 in a sealing manner at least along the entire workpiece edge by means of certain sealing strips, a gap-like intermediate space being enclosed between suction bell and workpiece 19. In the exemplary embodiment shown, this intermediate space is subdivided into a plurality of pockets 29 by a plurality of sealing lines running crosswise over the workpiece surface to be seized, the pockets 29 being sealed off from one another by the sealing profiles 28. Each of the pockets is provided with a separate vacuum connection 30 and thus can be subjected to vacuum on its own. In view of the reaction temperatures for curing the thermosetting SMC parts, the sealing profiles used for forming the sealing lines should be made of a material which is temperature-resistant at least up to about 140° C.

The sealing profiles 28 follow the course of the exposed workpiece surface 20 in a true-to-shape manner and can be brought to bear against the workpiece surface in a sealing manner. The relaxed, end-face profile shape 32 of the sealing profile is arched. It is not until it is under the effect of the vacuum and the applied pressure effected by the ambient air pressure that the sealing profile 28 is pressed flat against the workpiece surface at the end face. It is certainly true that, by the exertion of force in the pulling direction, the residual gas trapped in the pockets can expand, the gap between workpiece and suction bell can widen and the sealing profile can lift somewhat from the workpiece surface. However, due to the arch 32, which forms again in this situation, of the sealing end face, its sealing contact with the workpiece surface is retained. Even under the action of force and consequent widening of the pockets 29, the sealing profiles 28 remain tight and the vacuum is retained unchanged.

A situation may arise in which either the vacuum does not reach its desired level at all in one of the pockets 29 or the vacuum collapses in one of the pockets during the operation for releasing the workpiece by the removing gripper. There may be several reasons for this. One reason may be a defective workpiece, e.g. a workpiece having a rough or porous surface. Another reason for an inadequate vacuum may be local damage or disturbance of the sealing profile due to a foreign body or contamination. A further possibility for collapse of the vacuum in a pocket may be overstressing of the elasticity of the sealing profile, so that it lifts locally from the workpiece surface 20; ambient air then flows briefly into the pocket concerned and the vacuum collapses very quickly.

The individual pockets 29 are connected to one another via the supply lines to the individual vacuum connections 30. A respective safety valve 31 is arranged in the vacuum connection of each pocket 29 so that, despite the external line connection between the pockets and despite any leakage in one of the pockets, the vacuum does not collapse in all the other pockets and the entire removing gripper does not become ineffective. This safety valve 31 is designed in such a way that, in the event of any collapse of the vacuum in one of the pockets, the vacuum connection concerned is closed by the associated safety valve, so that no ambient air, or at most very little ambient air, can penetrate into the other pockets from the pocket affected by leakage.

An exemplary embodiment of such a safety valve 31 is shown in FIG. 3. An essential part of this device is a check valve 55, which, during undisturbed operation, stays in the open position shown, which on the one hand is brought about by the restoring spring 58 and on the other hand is predetermined by the supporting cage 61. In this open position of the safety valve there is an unhindered flow connection between the two line connections leading outward.

The valve member of the check valve 55 is guided in an axially movable manner by a delay piston 56, which in turn can slide in a piston space 57 largely closed on the outside. When the vacuum is superimposed, the air still located to begin with in the connected pocket 29 flows from below (connection 30) through the check valve 55 into the vacuum line leading to the right in FIG. 3. In the process, the intensely flowing air exerts a force acting in the closing direction on the check valve 55, the force definitely exceeding the force of the restoring spring 58. However, the air which is trapped in the piston space 57 and displaced by the delay piston 56 during such a closing movement, and which can only escape into the open via the adjustable delay restrictor 59, permits only very slow closing of the check valve 55. This delay time is proportioned in such a way that the associated pocket can be reliably evacuated. Nonetheless, the check valve 55 finally shifts into the closed position only during prolonged evacuation times due to leakage. However, if the desired level of vacuum in the connected pocket is reached within the delay time, the evacuation flow stops and the check valve 55 automatically returns under the effect of the restoring spring from a partially closed intermediate position into the open position shown.

If the vacuum should suddenly collapse in the connected pocket during the operation of the removing gripper, an intense evacuation flow again occurs in the safety valve, this evacuation flow lasting longer than the delay time, so that the check valve 55 shifts into the closed position with lasting effect. This local closing is intended to prevent a lasting flow of infiltrated air into the vacuum feed lines of the other pockets and to maintain the vacuum in the other pockets. In this state of the closed safety valve, vacuum feed is only possible via the adjustable bypass restrictor 60 across the check valve to the connected pocket. This is intended to ensure, if need be, a vacuum supply to the connected pocket in the event of the leakage forming again for any reason. This may happen, for example, by the removing gripper being pressed firmly against the workpiece 19 once again by the removing robot 13.

If a pocket 29 of the removing gripper 14 should remain permanently leaky during a removing operation, the associated safety valve 31 likewise remains permanently closed and only a small leakage flow of infiltrated air flows constantly into the vacuum supply via the adjustable bypass restrictor 60. However, this small infiltrated air quantity has no further harmful effect for maintaining the vacuum in the other pockets of the removing gripper. The vacuum there can nonetheless be easily kept at a level sufficient for detaching the workpiece 19 from the impression 26 of the lower die 24.

Of course, a leakage from the one or the other pocket 29 of the removing gripper 14 constitutes a disturbance which should be removed. On the other hand, an individual pocket which becomes leaky cannot be readily detected during automated operation, since the workpiece can be reliably held in place on the removing gripper by a still sufficient number of other pockets. Nonetheless, in order to be able to detect any leakage at the individual pockets, the vacuum feed to each individual pocket 29 is provided with a monitoring device 33 in the form of a barometer with integrated signal transducer. If the level of the respective vacuum drops below a pre-adjustable threshold value, this monitoring device emits a signal. Thus not only can the fact that a leakage has occurred at one of the pockets be detected, but the pocket at which the leakage has occurred can also be already established. As a result, on the one hand, the workpiece just removed can be specifically examined for any defects; on the other hand, the removing gripper itself can be specifically inspected for any foreign bodies in the sealing region or for damage to the seals. In addition, the signals, accumulating in the course of mass production, from the monitoring devices 33 can be evaluated for statistical purposes. In this way, for example, it can be discovered whether certain pockets become leaky especially frequently, and the magnitude of the vacuum loss, the phase of a working cycle in which the vacuum loss occurs and the speed with which the vacuum drops can be revealed. Together with recording the causes of the leakage, specific countermeasures which improve the production process can then be taken. Possible causes of leakages are, for example: workpiece porous, foreign bodies on sealing profile, sealing profile contaminated, sealing profile defective.

If the removing gripper 14 manipulated by the removing robot 13 is properly attached to the workpiece 19 located in the open tool of the press 12 and the vacuum is superimposed on the individual pockets 29 by the valve 40, the operation for carefully detaching the workpiece from the impression 26 can start, in the course of which rather high forces may possibly have to be exerted. In order to relieve the robot, in particular the working arm, the joints and drives, from the development of excessive forces on the one hand, but in order to be able to exert really high forces on the vacuum-held workpiece for detaching the latter on the other hand, a plurality of plungers 36 are attached to the edge of the suction bell and lie outside the region of the lower impression 26. The removing tool can be pushed off the lower die using these plungers, which can be actuated by servomotor and can be set down on opposing surfaces 37 on the lower die 24.

In the exemplary embodiment, four brackets 38 which project outward and in which pneumatic cylinders 35 are mounted are attached to the outer edge of the removing gripper 14. A respective pneumatic cylinder is arranged close to each corner of the removing gripper, which is rectangular in plan view. The piston rods of the piston rods, which can be moved back and forth in the lifting direction by these pneumatic cylinders in a servomotor-operated manner, constitute the plungers 36 referred to. The pneumatic cylinders 35 can be supplied with compressed air via the main valve 41.

The phase of detaching the workpiece from the impression is initiated with the activation of the compressed air, in the course of which compressed air is transmitted via a distributing device 42 to the individual pneumatic cylinders. Different “distribution programs”, e.g. two distribution programs, can be realized by means of the distribution device. For this purpose, the distribution device has a valve element which is both rotatable and axially displaceable in a fixed housing. One of the distribution programs, which are preset in the design of the distribution device, is selected by axially positioning the movable valve element within the housing. The program itself is realized by rotation of the valve element about its longitudinal axis.

The pushing-off force can be exerted in an intermittent or pulsating manner by the effect of the distribution device 42, the location of the force, which acts for a short time in each case, changing cyclically. As a result, it is also possible to carefully remove from the impression those workpieces which sit very tightly in the impression. The pneumatic cylinders are advantageously provided with a displacement sensor, by means of which the stroke covered by the associated plunger 36 can be detected. The pulsating pushing-off of the removing gripper 14 from the lower die 24 is continued until all four displacement sensors signal a sufficiently large stroke, from which it can be inferred that the workpiece has been detached from the impression at all four corners.

The simplest distribution program of the distribution device 42 consists in all four connected pneumatic cylinders being supplied simultaneously with compressed air and accordingly in the removing gripper being pushed off the lower die 24 at all four corners with the same force and synchronously. If a situation should arise in which the workpiece cannot be readily detached from the impression 26, another distribution program can be selected. Such modified programs can provide for the individual pneumatic cylinders to be acted upon with compressed air and relieved again cyclically one after the other. In this case, the individual pneumatic cylinders may in each case be acted upon in turn by compressed air with a phase displacement and may be completely relieved in between, so that the pushing-off force is only effective at one corner in each case, although the effective location of the pushing-off force is changed cyclically. In a modification of the distribution program, interim partial relief of the pneumatic cylinders may be provided, so that a minimum pushing-off force is constantly effective over the entire gripper circumference. Also conceivable is a further distribution program in which in each case two pneumatic cylinders are jointly acted upon by pressure at the same time and the other two are relieved or partly relieved and this pairing of loaded and relieved pneumatic cylinders is cyclically transposed.

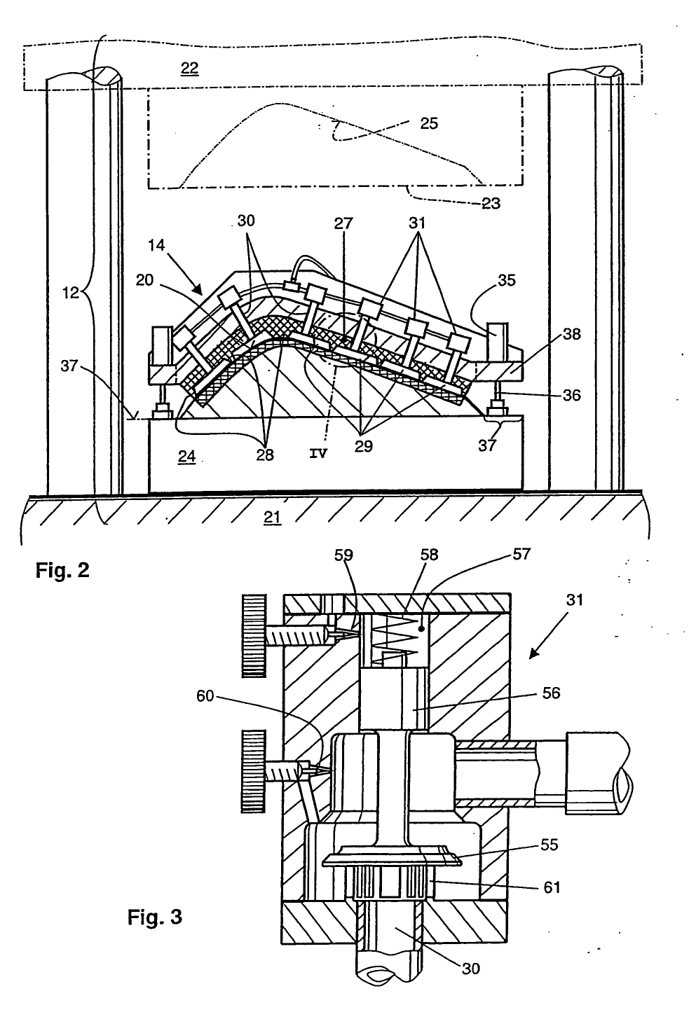

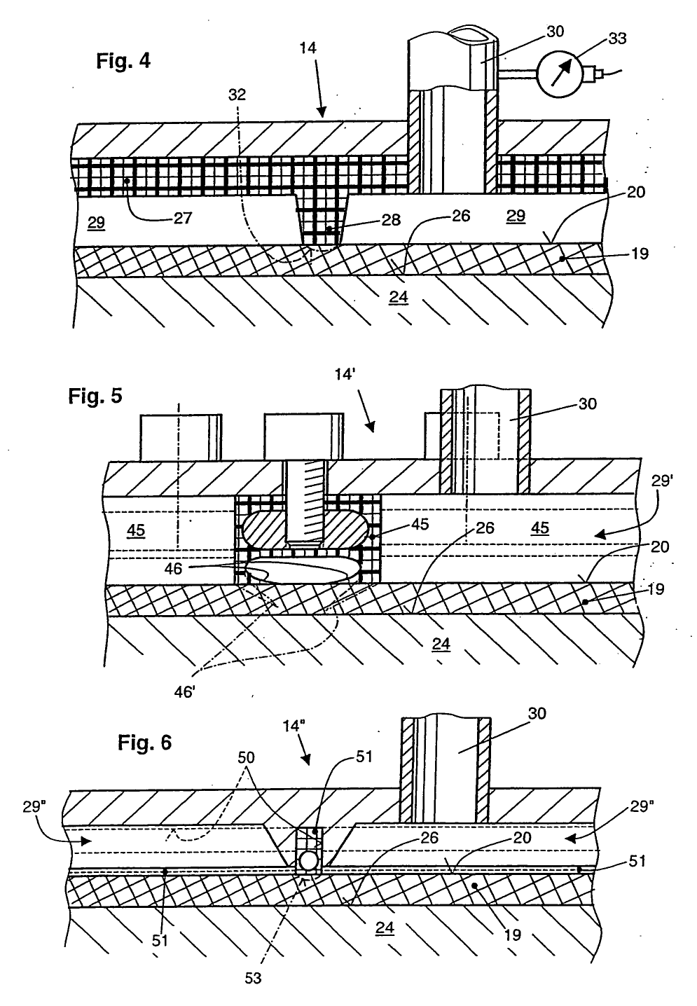

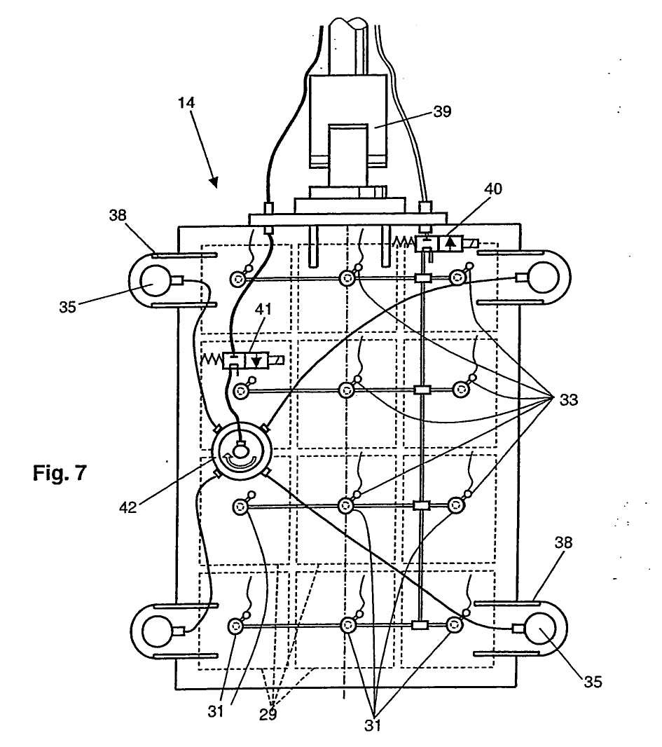

Finally, two modifications, indicated in FIGS. 5 and 6, of the removing grippers 14′ and 14″, respectively, are to be briefly dealt with. Whereas in the removing gripper 14 shown in FIGS. 2 and 4 a full-surface soft-material seating 27 is provided on the inside, from which the pockets 29 are fashioned and narrow sealing profiles 28 are left between adjacent pockets, in the removing gripper 14′ shown in FIG. 5 the pockets 29′ are formed by individual intersecting sealing strips 45 which abut against one another in a sealing fashion being screwed onto the inside of the shell of the removing gripper. In the exemplary embodiment of the sealing strips which is shown in FIG. 5, these sealing strips have two sealing lips 46 at the side in contact with the workpiece surface 20, these sealing lips 46 being arranged in mirror image and projecting in their relaxed shape 46′ slightly in the direction of the workpiece 19. Nonetheless, on account of this elastic design of the sealing lips, the sealing strip 45 can always conform to the workpiece surface 20 in a sealing manner even in the case of larger relative displacements and local geometrical errors.

In the exemplary embodiment, shown cut away in FIG. 6, of a removing gripper 14″, pockets 29″ are incorporated in its supporting shell, which is made of a hard and loadable construction material, and narrow webs running crosswise are left in said shell. Grooves 50 of, for example, rectangular cross section are milled in these webs, and a correspondingly shaped seal 51 made of a soft material is adhesively bonded in place in said grooves 50 in a firmly adhering manner. Here, too, in order to ensure a certain elasticity of movement and conformability, the exposed contact side is of arched design in its relaxed shape 53.

1-9. (canceled)

10. A device for detaching a finish-molded plastic workpiece from a lower impression of a compression molding tool, which is split into a lower die with a lower impression and an upper die with an upper impression and which can be opened and closed by a molding press, and for removing the workpiece from the molding press, during production of molded parts of reactive raw compounds of a thermoset, comprising a removing gripper which can be manipulated in a plurality of axes, wherein the removing gripper, which is also intended for detaching the workpiece from the lower impression of the lower die, is designed as a dimensionally stable suction bell adapted to the workpiece, covers the workpiece entirely in a true-to-shape manner on a workpiece surface, exposed in the lower die, up to the workpiece edge accessible in the lower die and, with a soft-material seating on the contact side of the suction bell, can be brought to bear in a sealing manner against the workpiece at least along the entire workpiece edge, and wherein it is possible for vacuum to be applied to a gap-like intermediate space enclosed between the suction bell and the workpiece.

11. The device as claimed in claim 10, wherein the soft-material seating covers the workpiece entirely at least along certain sealing lines and follows a course of the workpiece surface, exposed in the lower die, in a true-to-shape manner, it being possible for the sealing lines to be brought to bear against the workpiece surface in a sealing manner, and wherein pockets which are sealed off from one another and to which vacuum can be applied are exposed between the sealing lines.

12. The device as claimed in claim 11, wherein each of the pockets which are sealed off from one another is provided on the inside on the suction bell and is provided with a respective separate vacuum connection.

13. The device as claimed in claim 12, wherein a respective safety valve is arranged in each respective separate vacuum connection, which safety valve, upon any collapse of the vacuum in one of the pockets, closes the vacuum connection concerned in such a way that no more than only very little ambient air can penetrate into the other pockets from the pocket affected by leakage.

14. The device as claimed in claim 12, wherein a vacuum feed to each individual pocket is provided with a monitoring device which emits a signal if the level of the respective vacuum drops below a pre-adjustable threshold value.

15. The device as claimed in claim 10, wherein a plurality of plungers which lie outside the region of the lower impression, which can be set down on opposing surfaces on the lower die, and which can be moved back and forth in the lifting direction in a servomotor-operated manner, are attached to the edge of the removing gripper, and wherein the removing gripper can be pushed off the lower die by the plungers.

16. The device as claimed in claim 15, wherein the plungers are provided with a displacement sensor by which a stroke covered by the plunger can be detected.

17. The device as claimed in claim 10, wherein the removing gripper is attached to a wrist joint of a six-axis industrial robot.

18. The device as claimed in claim 11, wherein sealing profiles used for forming the sealing lines are made of a material which is temperature-resistant at least up to about 140° C.
